(19) United States
(12) Patent Application Publication
(10) Pub. No.: US 2008/0167432 A1
(43) Pub. Date: Jul. 10, 2008

(54) Curable Liquid Resin Composition

(75) Inventors: Hiroki Ohara, Tokyo (JP); Tsuyoshi Furukawa, Tokyo (JP); Takeo Shigemoto, Tokyo (JP); Zen Komiya, Tokyo (JP)

Correspondence Address: NIXON & VANDERHYE, PC, 901 NORTH GLEBE ROAD, 11TH FLOOR, ARLINGTON, VA, 22203, US

(73) Assignees: DSMIP ASSETS B.V., TE Heerlen (NL); JSR CORPORATION, Tokyo (JP)

(21) Appl. No.: 10/592,537

(22) PCT Filed: Mar. 15, 2005
(86) PCT No.: PCT/NL2005/000196

§ 371 Date: Dec. 20, 2007

(30) Foreign Application Priority Data
Mar. 15, 2004 (JP) 2004/072912

(51) Int. Cl. C08G 77/14; G02B 6/036

(52) U.S. Cl. 525/477; 528/10; 385/126

(57) ABSTRACT

The invention aims to provide a curable liquid resin composition which produces a cured product having excellent surface slip characteristics and printability and has excellent liquid resin stability. This problem is solved by providing a curable liquid resin composition, comprising a silicone including an alkyl-modified siloxane unit and a polyether-modified siloxane unit.

### TECHNICAL FIELD

The present invention relates to a curable liquid resin composition, in particular, a curable liquid resin composition useful as an optical fiber coating material, more particular, a matrix material. The invention also relates to coated optical fibers or a ribbon of optical fibers, comprising the cured composition according to the invention.

### BACKGROUND ART

An optical fiber is manufactured by spinning molten glass to obtain a glass fiber and applying a resin to the glass fiber for protection and reinforcement. As the resin coating, a structure in which a flexible primary coating layer is provided on the surface of the optical fiber, and a rigid secondary coating layer is provided on the primary coating layer has been known. An optical fiber ribbon or an optical fiber cable, in which a plurality of resin-coated optical fibers are secured by using a bundling material, has also well known. A resin composition for forming the primary coating layer of the optical fiber is called a primary material or inner primary, a resin composition for forming the secondary coating layer is called a secondary material or outer primary, and a resin composition used to bundle the optical fibers is called a bundling material, tape material or matrix material. It is also possible to apply a thin coloured layer of coating onto the secondary coating layer. Such a layer is typically called an ink layer, and usually has a thickness of between 3-10 μm. As the resin coating method, a method of applying a curable liquid resin composition and curing the applied composition using heat or light, in particular, ultraviolet rays has been widely used.

The secondary material and the bundling material are required to have a relatively high modulus of elasticity and have excellent mechanical characteristics such as high elongation at break. An optical fiber, a ribbon, a cable, or the like to which the secondary material or the bundling material has been applied is wound around a bobbin, and is stored or transported in a state in which the surfaces of the secondary material or the bundling material are in contact with each other. Therefore, a material having excellent surface characteristics to prevent adhesion between the surfaces has been demanded. Moreover, when the surface of the secondary material or the bundling material is colored or printed for identification using ink, it is desired that the ink be not removed from the coating layer.

As a curable liquid resin composition which forms a coating layer having improved surface characteristics, a composition containing a polydimethylpolysiloxane compound including (i) at least two urethane bonds, (ii) a nonreactive organic group at least at one terminal, and (iii) a (meth)acryloyl group at least at one terminal in one molecule has been proposed (Japanese Patent Application Laid-open No. 9-278850). However, since a cured product of this composition has poor ink colorability and printability, the coating layer cannot be printed.

A curable liquid resin composition containing a reaction product of a hydroxyl group-containing polydimethylsiloxane compound, a polyisocyanate compound, and a hydroxyl group-containing compound has also been proposed (Japanese Patent Application Laid-open No. 2002-138127). A cured product of this composition has excellent surface characteristics and ink colorability. However, since this composition has problems such as difficulty in production and poor liquid resin stability, a further improvement has been demanded.

### DISCLOSURE OF THE INVENTION

### Problems to be Solved by the Invention

An object of the present invention is to provide a curable liquid resin composition which produces a cured product having excellent surface slip characteristics and adhesion to ink, has excellent liquid resin stability, and can be easily produced at low cost.

### Means for Solving the Problem

The present inventors conducted various studies on a resin composition which satisfies the above characteristics, and attempted incorporating a polyether-modified silicone. However, a cured product of the composition including a polyether-modified silicone exhibited excellent printability at the cost of surface slip characteristics, or exhibited excellent surface slip characteristics at the cost of printability. Therefore, a composition which satisfies both of these characteristics could not be obtained. The present inventors then attempted incorporating an alkyl-modified silicone. A cured product of the composition including an alkyl-modified silicone exhibited excellent surface slip characteristics and printability, but exhibited poor liquid resin stability. Therefore, the present inventors have attempted incorporating a silicone including an alkyl-modified siloxane unit and a polyether-modified siloxane unit. As a result, the present inventors have found that a curable liquid resin composition exhibiting excellent surface slip characteristics and printability of the cured product and exhibiting excellent liquid resin stability can be obtained. This finding has led to the completion of the present invention.

Specifically, the present invention provides a curable liquid resin composition, comprising (A) a silicone product including a silicone (A1) including in its structure an alkyl-modified siloxane unit and a polyether-modified siloxane unit.

### EFFECT OF THE INVENTION

A cured product exhibiting surface slip characteristics and printability in combination can be obtained, and excellent storage stability of the liquid resin can also be obtained by using the curable liquid resin composition of the present invention. Moreover, the curable liquid resin composition of the present invention can be easily produced at low cost. Therefore, the curable liquid resin composition of the present invention is suitable as an optical fiber coating material, particularly as the secondary material and the bundling material.

### BEST MODE FOR CARRYING OUT THE INVENTION

The silicone (A) used in the curable liquid resin composition of the present invention is a product including a silicone (A1) including in its structure a siloxane unit including at least one alkyl group having two or more carbon atoms (hereinafter called “alkyl-modified siloxane unit”) and a siloxane unit including at least one polyalkylene oxide residue (hereinafter called “polyether-modified siloxane unit”). The structure of a siloxane unit other than the alkyl-modified siloxane unit and the polyether-modified siloxane unit is not particularly limited. The silicone (A1) in (A) may include a dimethylsiloxane unit.

The alkyl-modified siloxane unit accounts for preferably 0.5-45 mol %, still more preferably 1-45 mol %, and particularly preferably 2-45 mol % of the total siloxane units in the silicone (A1). The polyether-modified siloxane unit accounts for preferably 0.5-25 mol %, still more preferably 1-20 mol %, and particularly preferably 2.5-20 mol % of the total siloxane units. The silicone (A1) including the alkyl-modified siloxane unit and the polyether-modified siloxane unit at the above ratio is preferable from the viewpoint of surface slip characteristics and printability of the resulting cured product and stability of the liquid resin. The content of the alkyl-modified siloxane unit is preferably 40 mol % or more of the total content of the alkyl-modified siloxane unit and the polyether-modified siloxane unit for the same reasons. The silicone product (A) includes the silicone (A1), of which the molecules which satisfy the above-mentioned alkyl modification rate and the polyether modification rate in an amount of preferably 20 mol % or more, still more preferably 50 mol % or more, and particularly preferably 80 mol % or more of the total amount of the component (A).

As the alkyl group of the alkyl-modified siloxane unit, a linear or branched alkyl group having 2-50, preferably 2-15, and particularly preferably 2-10 carbon atoms is preferable. As the polyalkylene oxide residue (POA) of the polyether-modified siloxane unit, a poly(C₁₋₅ alkylene oxide) residue such as a polyethylene oxide residue, a polypropylene oxide residue, or a polybutylene oxide residue is preferable. Of these, a polyethylene oxide residue is particularly preferable. The number of POA repeating units is preferably 2-50, still more preferably 2-15, and particularly preferably 2-10. The terminal of the main chain of the silicone (A1) is an organic group having preferably 1-100, still more preferably 1-50, and particularly preferably 1-24 carbon atoms. Of these, a linear or branched alkyl group is preferable. The average molecular weight of the silicone (A1) is preferably 500-300,000, still more preferably 500-100,000, and particularly preferably 500-50,000.

As commercially available products of the silicone product (A), Paintad 8586 (manufactured by Dow Corning Asia Limited) and the like can be given.

The silicone product (A) is included in the curable liquid resin composition of the present invention in an amount of preferably 0.01-20 mass %, still more preferably 0.05-15 mass %, and particularly preferably 0.1-10 mass % from the viewpoint of storage stability of the liquid resin and surface slip characteristics and printability of the cured product.

The curable liquid resin composition of the present invention may include, in addition to the silicone product (A), (B) a urethane (meth)acrylate obtained by reacting a polyol compound, a polyisocyanate compound, and a hydroxyl group-containing (meth)acrylate compound, and (C) a polymerizable diluent. The urethane (meth)acrylate obtained by reacting the polyol compound, the polyisocyanate compound, and the hydroxyl group-containing (meth)acrylate compound (hereinafter referred to as “urethane (meth)acrylate (B)”) is usually produced by reacting the isocyanate group of the polysocyanate with the hydroxyl group of the polyol compound or the hydroxyl group of the hydroxyl group-containing (meth)acrylate compound.

When synthesizing the urethane acrylate (B), the polyol compound, the polyisocyanate compound, and the hydroxyl group-containing (meth)acrylate compound are preferably used so that the isocyanate group of the diisocyanate compound and the hydroxyl group of the hydroxyl group-containing (meth)acrylate are respectively 1.1-2 equivalents and 0.1-1 equivalent for one equivalent of the hydroxyl group of the polyol compound.

As a specific method for carrying out this reaction, a method of reacting the polyol compound, the diisocyanate compound, and the hydroxyl group-containing (meth)acrylate compound all together; a method of reacting the polyol compound with the diisocyanate compound, and reacting the resulting product with the hydroxyl group-containing (meth)acrylate compound; a method of reacting the diisocyanate compound with the hydroxyl group-containing (meth)acrylate compound, and reacting the resulting product with the polyol compound; and a method of reacting the diisocyanate compound with the hydroxyl group-containing (meth)acrylate compound, reacting the resulting product with the polyol compound, and further reacting the resulting product with the hydroxyl group-containing (meth)acrylate compound; and the like can be given.

As examples of the diisocyanate compound used for synthesizing the urethane acrylate (B), an aromatic diisocyanate, alicyclic diisocyanate, aliphatic diisocyanate, and the like can be given. As examples of the aromatic diisocyanate, 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, bis(2-isocyanatoethyl)fumarate, 6-isopropyl-1,3-phenyl diisocyanate, 4-diphenylpropane diisocyanate, tetramethylxylylene diisocyanate, and the like can be given. As examples of the alicyclic diisocyanate, isophorone diisocyanate, methylenebis(4-cyclohexylisocyanate), hydrogenated diphenylmethane diisocyanate, hydrogenated xylylene diisocyanate, 2,5-bis(isocyanatomethyl)-bicyclo[2.2.1]heptane, 2,6-bis(isocyanatomethyl)-bicyclo[2.2.1]heptane, and the like can be given. As examples of the aliphatic diisocyanate, 1,6-hexane diisocyanate, 2,2,4-trimethylhexamethylene diisocyanate, lysine diisocyanate, and the like can be given. Of these, 2,4-tolylene diisocyanate and isophorone diisocyanate are particularly preferable. These diisocyanates may be used either individually or in combination of two or more.

As examples of the hydroxyl group-containing (meth)acrylate compound used for synthesizing the urethane acrylate (B), 2-hydroxyethyl (meth)acrylate, 2-hydroxypropyl (meth)acrylate, 2-hydroxybutyl (meth)acrylate, 2-hydroxy-3-phenyloxypropyl (meth)acrylate, 1,4-butanediol mono(meth)acrylate, 2-hydroxyalkyl(meth)acryloyl phosphate, 4-hydroxycyclohexyl (meth)acrylate, 1,6-hexanediol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate, and (meth)acrylates shown by the following formulas (1) and (2) can be given.

H₂C═C(R¹)COOCH₂CH₂(OCOCH₂Ch₂CH₂CH₂CH₂)ₙOH (1)

H₂C═C(R¹)COOCH₂CH(OH)CH₂OC₆H₅ (2)

wherein R¹ represents a hydrogen atom or a methyl group, and n is an integer from 1 to 15. A compound obtained by the addition reaction of (meth)acrylic acid with a glycidyl group-containing compound such as an alkyl glycidyl ether, allyl glycidyl ether, and glycidyl (meth)acrylate may also be used. The hydroxyl group-containing (meth)acrylate may be used either individually or in combination of two or more.

As examples of the polyol compound used for producing the urethane acrylate (B), a polyether diol such as an aliphatic polyether diol, alicyclic polyether diol, or aromatic polyether diol, polyester diol, polycarbonate diol, polycaprolactone diol, and the like can be given. The polyol may be used either individually or in combination of two or more. A polyol having two or more hydroxyl groups synthesized by reacting a diol with a polyisocyanate may also be used as the polyol. There are no specific limitations to the manner of polymerization of each structural unit of the polyol, which may be any of random polymerization, block polymerization, and graft polymerization.

As examples of the aliphatic polyether diol, polyethylene glycol, polypropylene glycol, polytetramethylene glycol, polyhexamethylene glycol, polyheptamethylene glycol, polydecamethylene glycol, polyether diol obtained by ring-opening copolymerization of two or more ion-polymerizable cyclic compounds, and the like can be given.

As examples of the ion-polymerizable cyclic compound, cyclic ethers such as ethylene oxide, propylene oxide, butene-1-oxide, isobutene oxide, 3,3-bischloromethyloxetane, tetrahydrofuran, 2-methyltetrahydrofuran, 3-methyltetrahydrofuran, dioxane, trioxane, tetraoxane, cyclohexene oxide, styrene oxide, epichlorohydrin, glycidyl methacrylate, allyl glycidyl ether, allyl glycidyl carbonate, butadiene monoxide, isoprene monoxide, vinyloxetane, vinyltetrahydrofuran, vinylcyclohexene oxide, phenyl glycidyl ether, butyl glycidyl ether, and glycidyl benzoate can be given.

As specific examples of the polyether diols obtained by ring-opening copolymerization of two or more of the ion-polymerizable cyclic compounds, binary copolymers obtained by ring-opening copolymerization of the combination of monomers such as tetrahydrofuran and propylene oxide, tetrahydrofuran and 2-methyltetrahydrofuran, tetrahydrofuran and 3-methyltetrahydrofuran, tetrahydrofuran and ethylene oxide, propylene oxide and ethylene oxide, and butene-1-oxide and ethylene oxide, ternary copolymers obtained by ring-opening copolymerization of the combination of monomers such as tetrahydrofuran, butene-1-oxide, and ethylene oxide, and the like can be given. A polyether diol obtained by ring-opening copolymerization of the ion-polymerizable cyclic compound and a cyclic imine such as ethyleneimine, cyclic lactone such as β-propiolactone or lactide glycolate, or dimethylcyclopolysiloxane may also be used.

The above aliphatic polyether diols are commercially available as PTMG 650, PTMG 1000, PTMG 2000 (manufactured by Mitsubishi Chemical Corp.), PPG400, PPG1000, Excenol 720, 1020, 2020 (manufactured by Asahi Oline Co., Ltd.), PEG1000, Unisafe DC1100, DC1800 (manufactured by Nippon Oil and Fats Co., Ltd.), PPTG2000, PPTG1000, PTG400, PTGL2000 (manufactured by Hodogaya Chemical Co., Ltd.), and Z-3001-4, Z-3001-5, PBG2000A, PBG2000B, EO/BO4000, and EO/BO2000 (manufactured by Dai-ichi Kogyo Seiyaku Co., Ltd.).

As examples of the alicyclic polyether diols, alkylene oxide addition diol of hydrogenated bisphenol A, alkylene oxide addition diol of hydrogenated bisphenol F, alkylene oxide addition diol of 1,4-cyclohexanediol, and the like can be given. As examples of the aromatic polyether diols, alkylene oxide addition diol of bisphenol A, alkylene oxide addition diol of bisphenol F, alkylene oxide addition diol of hydroquinone, alkylene oxide addition diol of naphthohydroquinone, alkylene oxide addition diol of anthrahydroquinone, and the like can be given. The aromatic polyether diols are commercially available as Uniol DA400, DA700, DA1000, DA4000 (manufactured by Nippon Oil and Fats Co., Ltd.), and the like.

As examples of the polyester diols, a polyester diol obtained by reacting a polyhydric alcohol with a polybasic acid, and the like can be given. As examples of the polyhydric alcohol, ethylene glycol, polyethylene glycol, propylene glycol, polypropylene glycol, tetramethylene glycol, polytetramethylene glycol, 1,6-hexanediol, neopentyl glycol, 1,4-cyclohexanedimethanol, 3-methyl-1,5-pentanediol, 1,9-nonanediol, 2-methyl-1,8-octanediol, and the like can be given. As examples of the polybasic acid, phthalic acid, isophthalic acid, terephthalic acid, maleic acid, fumaric acid, adipic acid, sebacic acid, and the like can be given.

As examples of commercially available products of the above polyester diols, Kurapol P-2010, P-1010, L-2010, L-1010, A-2010, A-1010, F-2020, F-1010, PMIPA-2000, PKA-A, PNOA-2010, PNOA-1010 (manufactured by Kuraray Co., Ltd.), and the like can be given.

As examples of the polycarbonate diols, polycarbonate of polytetrahydrofuran, polycarbonate of 1,6-hexanediol, and the like can be given. As commercially available products of the polycarbonate diols, DN-980, 981, 982, 983 (manufactured by Nippon Polyurethane Industry Co., Ltd.), PC-8000 (manufactured by PPG of the U.S.), PC-THF-CD (manufactured by BASF), and the like can be given. As examples of the polycaprolactone diols, a polycaprolactone diol obtained by reacting ε-caprolactone with a diol, and the like can be given. As examples of such a diol, ethylene glycol, polyethylene glycol, propylene glycol, polypropylene glycol, tetramethylene glycol, polytetramethylene glycol, 1,2-polybutylene glycol, 1,6-hexanediol, neopentyl glycol, 1,4-cyclohexanedimethanol, 1,4-butanediol, and the like can be given. The polycaprolactone diols are commercially available as Placcel 205, 205AL, 212, 212AL, 220, 220AL (manufactured by Daicel Chemical Industries, Ltd.), and the like.

Examples of polyols other than the above-mentioned polyols include ethylene glycol, propylene glycol, 1,4-butanediol, 1,5-pentanediol, 1,6-hexanediol, neopentyl glycol, 1,4-cyclohexanedimethanol, hydrogenated bisphenol A, hydrogenated bisphenol F, dimethylol compound of dicyclopentadiene, tricyclodecanedimethanol, pentacyclodecanedimethanol, β-methyl-δ-valerolactone, hydroxy-terminated polybutadiene, hydroxy-terminated hydrogenated polybutadiene, castor oil-modified polyol, diol-terminated polydimethylsiloxane compound, polydimethylsiloxane carbitol-modified polyol, and the like. A diamine may be used in the preparation of the urethane acrylate (B) in combination with the polyol. As examples of such a diamine, ethylenediamine, tetramethylenediamine, hexamethylenediamine, p-phenylenediamine, 4,4′-diaminodiphenylmethane, diamine containing a hetero atom, polyether diamine, and the like can be given.

A part of the hydroxyl group-containing (meth)acrylate may be replaced by a compound having a functional group which can be added to an isocyanate group. As examples of such a compound, γ-aminopropyltriethoxysilane, γ-mercaptopropyltrimethoxysilane, and the like can be given. Use of these compounds improves adhesion to substrates such as glass. In the synthesis of the urethane acrylate (B), a urethanization catalyst selected from copper naphthenate, cobalt naphthenate, zinc naphthenate, dibutyltin dilaurate, triethylamine, 1,4-diazabicyclo[2.2.2]octane, and 2,6,7-trimethyl-1,4-diazabicyclo[2.2.2]octane is preferably used in an amount of 0.01-1 mass % of the total amount of the reactants. The reaction is preferably carried out at 5-90° C., and particularly preferably at 10-80° C.

The polystyrene-reduced molecular weight of the urethane acrylate (B) measured by gel permeation chromatography is preferably 500-20,000, and still more preferably 700-15,000. If the molecular weight is less than 500, the resulting cured product may exhibit low elongation at break. If the molecular weight is more than 20,000, the viscosity may be increased. The urethane acrylate (B) is included in the curable liquid resin composition of the present invention in an amount of preferably 30-90 mass %, and particularly preferably 40-85 mass %. If the amount is less than 30 mass %, the modulus of elasticity of the resulting cured product may show a large temperature dependence. If the amount is more than 90 mass %, the viscosity of the curable liquid resin composition may be increased.

A urethane (meth)acrylate obtained by reacting 1 mol of the diisocyanate with 2 mol of the hydroxyl group-containing (meth)acrylate compound may be included in the curable liquid resin composition of the present invention. As examples of such a urethane (meth)acrylate, a reaction product of hydroxyethyl (meth)acrylate and 2,5-(or 2,6-)bis(isocyanatemethyl)-bicyclo[2.2.1]heptane, a reaction product of hydroxyethyl (meth)acrylate and 2,4-tolylene diisocyanate, a reaction product of hydroxyethyl (meth)acrylate and isophorone diisocyanate, a reaction product of hydroxypropyl (meth)acrylate and 2,4-tolylene diisocyanate, a reaction product of hydroxypropyl (meth)acrylate and isophorone diisocyanate, and the like can be given.

The curable liquid resin composition of the present invention may further include the polymerizable diluent (C), which is an ethylenically unsaturated monomer. As the polymerizable diluent (C), a monofunctional compound and/or a polyfunctional compound is used. As examples of the monofunctional compound, vinyl group-containing lactams such as N-vinylpyrrolidone and N-vinylcaprolactam, alicyclic structure-containing (meth)acrylates such as isobornyl (meth)acrylate, bornyl (meth)acrylate, tricyclodecanyl (meth)acrylate, dicyclopentanyl (meth)acrylate, dicyclopentenyl (meth)acrylate, and cyclohexyl (meth)acrylate, benzyl (meth)acrylate, 4-butylcyclohexyl (meth)acrylate, acryloylmorpholine, vinylimidazole, vinylpyridine, and the like can be given. Further examples include 2-hydroxyethyl (meth)acrylate, 2-hydroxypropyl (meth)acrylate, 4-hydroxybutyl acrylate, methyl (meth)acrylate, ethyl (meth)acrylate, propyl (meth)acrylate, isopropyl (meth)acrylate, octyl (meth)acrylate, isooctyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, tetrahydrofurfuryl (meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, diacetone(meth)acrylamide, isobutoxymethyl(meth)acrylamide, N,N-dimethyl(meth)acrylamide, t-octyl(meth)acrylamide, dimethylaminoethyl (meth)acrylate, diethylaminoethyl (meth)acrylate, 7-amino-3,7-dimethyloctyl (meth)acrylate, N,N-diethyl(meth)acrylamide, N,N-dimethylaminopropyl(meth)acrylamide, hydroxybutyl vinyl ether, lauryl vinyl ether, cetyl vinyl ether, 2-ethylhexyl vinyl ether, and the like.

As commercially available products of these monofunctional compounds, Aronix M-111, M-113, M-114, M-117 (manufactured by Toagosei Co., Ltd.), Kayarad TC110S, R629, R644 (manufactured by Nippon Kayaku Co., Ltd.), IBXA, Viscoat 3700 (manufactured by Osaka Organic Chemical Industry Co., Ltd.), and the like can be given.

As examples of the polyfunctional compound, trimethylolpropane tri(meth)acrylate, pentaerythritol tri(meth)acrylate, ethylene glycol di(meth)acrylate, tetraethylene glycol di(meth)acrylate, polyethylene glycol di(meth)acrylate, 1,4-butanediol di(meth)acrylate, 1,6-hexanediol di(meth)acrylate, neopentyl glycol di(meth)acrylate, trimethylolpropanetrioxyethyl (meth)acrylate, tris(2-hydroxyethyl)isocyanurate tri(meth)acrylate, tris(2-hydroxyethyl)isocyanurate di(meth)acrylate, tricyclodecanedimethanol di(meth)acrylate, di(meth)acrylate of ethylene oxide or propylene oxide addition diol of bisphenol A, di(meth)acrylate of ethylene oxide or propylene oxide addition diol of hydrogenated bisphenol A, epoxy (meth)acrylate obtained by addition of (meth)acrylate to diglycidyl ether of bisphenol A, triethylene glycol divinyl ether, and the like can be given. As commercially available products of the polyfunctional compounds, Yupimer UV SA1002, SA2007 (manufactured by Mitsubishi Chemical Corp.), Viscoat 700 (manufactured by Osaka Organic Chemical Industry, Ltd.), Kayarad R-604, DPCA-20, DPCA-30, DPCA-60, DPCA-120, HX-620, D-310, D-330 (manufactured by Nippon Kayaku Co., Ltd.), Aronix M-210, M-215, M-315, M-325 (manufactured by Toagosei Co., Ltd.), and the like can be given.

The polymerizable diluent (C) is included in the curable liquid resin composition of the present invention in an amount of preferably 0-80 mass %, and particularly preferably 20-70 mass % from the viewpoint of the curing speed and the viscosity (applicability) of the liquid composition.

The curable liquid resin composition of the present invention may further include a polymerization initiator. As the polymerization initiator, a heat polymerization initiator or a photoinitiator may be used. There are no specific limitations to the curing method. The curable liquid resin composition is usually cured using radiation and/or heat. In particular, curing using ultraviolet rays is preferable.

When curing the curable liquid resin composition of the present invention using heat, a heat polymerization initiator such as a peroxide or an azo compound may usually be used. As specific examples of the heat polymerization initiator, benzoyl peroxide, t-butyl-oxybenzoate, azobisisobutyronitrile, and the like can be given.

A photoinitiator is used when curing the curable liquid resin composition of the present invention using light. In addition, a photosensitizer may optionally be added. As examples of the photoinitiator, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyldiphenylphosphine oxide, bis-(2,6-dimethoxybenzoyl)-2,4,4-trimethylpentylphosphine oxide, and the like can be given. As commercially available products of the photoinitiator, Irgacure 184, 369, 651, 500, 907, CGI1700, CGI1750, CGI1850, CG24-61, Darocur 1116, 1173, 4625 (manufactured by Ciba Specialty Chemicals Co., Ltd.), Lucirin TPO (manufactured by BASF), Ubecryl P36 (manufactured by UCB), and the like can be given. As examples of the photosensitizer, triethylamine, diethylamine, N-methyldiethanolamine, ethanolamine, 4-dimethylaminobenzoic acid, methyl 4-dimethylaminobenzoate, ethyl 4-dimethylaminobenzoate, isoamyl 4-dimethylaminobenzoate, and the like can be given. As commercially available products of the photosensitizer, Ubecryl P102, 103, 104, 105 (manufactured by UCB), and the like can be given. The polymerization initiator is included in the curable liquid composition of the present invention in an amount of preferably 0.1-10 mass %, and particularly preferably 0.3-7 mass %.

Various additives such as antioxidants, coloring agents, UV absorbers, light stabilizers, silane coupling agents, heat polymerization inhibitors, leveling agents, surfactants, preservatives, plasticizers, lubricants other than hydrocarbon compounds, solvents, fillers, aging preventives, wettability improvers, and coating surface improvers may optionally be included in the curable liquid resin composition in addition to the above-described components. As examples of antioxidants, 2,2′-thiodiethyl-bis-[3-(3,5-di-t-butyl-4-hydroxyphenyl)-propionate], octadecyl-3-(3,5-di-t-butyl-4-hydroxyphenyl)propionate, and the like can be given. As commercially available products of these compounds, Irganox 1010, 1035, 1076, 1222, (manufactured by Ciba Specialty Chemicals Co., Ltd), Antigene P, 3C, FR, GA-80 (manufactured by Sumitomo Chemical Industries Co., Ltd.), and the like can be given. As examples of UV absorbers, 2-(5-methyl-2-hydroxyphenyl)benzotriazole, 2-(3-t-butyl-5-methyl-2-hydroxyphenyl)-5-chlorobenzotriazole, and the like can be given. As commercially available products of these compounds, Tinuvin P, 234, 320, 326, 327, 328, 329, 213 (manufactured by Ciba Specialty Chemicals Co., Ltd.), Seesorb 102, 103, 501, 202, 712, 704 (manufactured by Shipro Kasei Kaisha, Ltd.), and the like can be given. As examples of light stabilizers, 2-(3,5-di-t-butyl-4-hydroxybenzyl)-2-n-butylmalonic acid bis(1,2,2,6,6-pentamethyl-4-piperidyl), a polymer of dimethyl succinate and 4-hydroxy-2,2,6,6-tetramethyl-1-piperidineethanol, and the like can be given. As commercially available products of these compounds, Tinuvin 292, 144, 622LD (manufactured by Ciba Specialty Chemicals Co., Ltd.), Sanol LS770 (manufactured by Sankyo Co., Ltd.), TM-061 (manufactured by Sumitomo Chemical Industries Co., Ltd.), and the like can be given. As examples of silane coupling agents, γ-aminopropyltriethoxysilane, γ-mercaptopropyltrimethoxysilane, γ-methacryloxypropyltrimethoxysilane, and the like can be given. As commercially available products of these compounds, SH6062, SH6030 (manufactured by Toray-Dow Corning Silicone Co. Ltd.), KBE 903, 603, 403 (manufactured by Shin-Etsu Chemical Co., Ltd.), and the like can be given. As examples of coating surface improvers, a graft polymer of dimethylsiloxane polycarbinol, and the like can be given. As commercially available products, SH28PA and SH190 (manufactured by Toray-Dow Corning Silicone Co., Ltd.) and the like can be given.

Other oligomers, polymers, and additives may optionally be included in the curable liquid resin composition of the present invention insofar as the characteristics of the composition are not impaired. As examples of such other oligomers or polymers, polyester (meth)acrylate, epoxy (meth)acrylate, polyamide (meth)acrylate, siloxane polymers having a (meth)acryloyloxy group, glycidyl methacrylate, and the like can be given. The curable liquid resin composition of the present invention is cured using heat or radiation. Radiation used herein includes infrared radiation, visible rays, ultraviolet rays, X-rays, electron beams, α-rays, β-rays, γ-rays, and the like, with ultraviolet rays being particularly preferable.

### EXAMPLES

The present invention is described below in more detail by examples. However, the present invention is not limited to these examples. In the following examples, parts mean parts by weight.

### Synthesis Example 1

### Synthesis Example of Urethane Acrylate

A reaction vessel equipped with a stirrer was charged with 21.516 parts of 2,4-tolylene diisocyanate, 23.742 parts of polypropylene glycol with a hydroxyl equivalent of 2,000, 0.058 part of dibutyltin dilaurate, and 0.017 part of 2,6-di-t-butyl-p-cresol. The mixture was allowed to react at 15-30° C. until the residual isocyanate content became 20.7 wt % or less. After the addition of 7.258 parts of 2-hydroxypropyl acrylate dropwise, the mixture was allowed to react at 15-30° C. until the residual isocyanate content became 13.5 wt % or less. After the addition of 19.457 parts of 2-hydroxyethyl acrylate dropwise, the mixture was allowed to react at 30-70° C. until the residual isocyanate content became 0.1 wt % or less. As a result, a homogenous transparent liquid was obtained. This liquid resin is referred to as UA-1.

### Examples 1-2

A reaction vessel equipped with a stirrer was charged with compounds at a ratio shown in Table 1. The mixture was stirred at 50-60° C. for three hours to obtain compositions of Examples 1-2. The amount of each component in Table 1 is indicated by part by weight.

### Comparative Examples 1-5

Compositions of Comparative Examples 1-5 were obtained in the same manner as in Examples 1-2 except for using the compounds at a ratio shown in Table 1.

### Test Example

The curable liquid resin composition obtained in the above example was cured using the following method to prepare a specimen. The specimen was evaluated as follows. The results are shown in Table 1.

### 1. Preparation of Specimen

The curable liquid resin composition was applied to a glass plate using a applicator bar with a gap size of 250 μm. The applied composition was irradiated with ultraviolet rays in nitrogen at a dose of 0.5 J/cm². The resulting cured product was allowed to stand at a temperature of 23° C. and a humidity of 50% for 12 hours or more to prepare a specimen.

### 2. Surface Slip Characteristic Test

The cured product obtained by the above-described method was removed from the glass plate, cut at a width of 3 cm, and secured to an aluminum plate using a double-sided adhesive tape so that the surface irradiated with ultraviolet rays faces the upside. The surfaces of the cured products were attached using two specimens, fastened using a double clip, and subjected to a surface slip test. A shear slip test was conducted at a tensile rate of 50 mm/min, a cured product surface contact area of 5.4 cm², and a double clip pressure of 4.7 N/cm² to calculate the shear slip force from the load when the specimen started to slip (unit: N/cm²).

### 3. Evaluation of Ink Adhesion

An ink-jet printer ink (“INK7110 (black)” manufactured by IMAJE) was uniformly applied to the cured surface of the specimen obtained by the above method using a spin coater at a revolution rate of 8,000 rpm for 20 seconds. The specimen was allowed to stand at a temperature of 23° C. and a humidity of 50% for 12 hours or more. The ink adhesion was evaluated by performing a cross-cut tape method according to JIS K 5400. The ink adhesion was evaluated by the number of remaining squares.

### 4. Measurement of Liquid Storage Stability

The liquid storage stability of the curable liquid resin composition was evaluated by allowing the curable liquid resin composition to stand at 60° C. for 30 days, applying the liquid resin dropwise to a glass plate, and observing the presence or absence of separation at the liquid surface with the naked eye. The liquid storage stability was evaluated by the number of days elapsed until separation was confirmed at the liquid surface.

TABLE 1

| | | | Comparative | Comparative | Comparative | Comparative | Comparative |
|---|---|---|---|---|---|---|---|
| Component (part) | Example 1 | Example 2 | Example 1 | Example 2 | Example 3 | Example 4 | Example 5 |
| Coating surface improver (a1) | 2.0 | 2.0 | — | — | — | — | — |
| Coating surface improver (a2) | — | 0.2 | 2.0 | — | — | — | — |
| Coating surface improver (a3) | — | — | — | 2.0 | — | — | — |
| Coating surface improver (a4) | — | — | — | — | 2.0 | — | — |
| Coating surface improver (a5) | — | — | — | — | — | 2.0 | — |
| Coating surface improver (a6) | — | — | — | — | — | — | 2.0 |
| UA-1 | 100.0 | 100.0 | 100.0 | 100.0 | 100.0 | 100.0 | 100.0 |
| Polymerization initiator (p1) | 0.4 | 0.4 | 0.4 | 0.4 | 0.4 | 0.4 | 0.4 |
| Polymerization initiator (p2) | 2.5 | 2.5 | 2.5 | 2.5 | 2.5 | 2.5 | 2.5 |
| Surface slip characteristics | 6 | 7 | 25 | 13 | 10 | 7 | 6 |
| (N/cm²) | | | | | | | |
| Ink adhesion¹⁾ | 100 | 100 | 100 | 50 | 0 | 100 | 100 |
| Liquid storage stability (day)²⁾ | >30 | >30 | >30 | >30 | >30 | 7 | 14 |

(a1) Polyether-alkyl-modified silicone (Paintad 8586 manufactured by Dow Corning Asia Limited)
(a2) Polyether-modified silicone (SH190 manufactured by Toray-Dow Corning Silicone Co., Ltd.)
(a3) Polyether-modified silicone (SH3711 manufactured by Toray-Dow Corning Silicone Co., Ltd.)
(a4) Polyether-modified silicone (SH8427 manufactured by Toray-Dow Corning Silicone Co., Ltd.)
(a5) Alkyl-modified silicone (SH203 manufactured by Toray-Dow Corning Silicone Co., Ltd.)
(a6) Alkyl-modified silicone (SH230 manufactured by Toray-Dow Corning Silicone Co., Ltd.)
(p1) 2,4,6-Trimethylbenzoyldiphenylphosphine oxide
(p2) 1-Hydroxycyclohexyl phenyl ketone
¹⁾Number of remaining squares (total number of squares was 100)
²⁾Date at which oil droplet was confirmed or two-phase separation was confirmed.

As is clear from Table 1, the compositions of Comparative Example 1-3 containing a polyether-modified silicone exhibited excellent liquid resin stability. However, the surface slip characteristics and the ink adhesion (printability) of the cured product were not satisfied in combination. The compositions of Comparative Example 4 and 5 containing an alkyl-modified silicone exhibited excellent surface slip characteristics and ink adhesion of the cured product, but exhibited poor liquid resin stability. On the other hand, the compositions of the present invention including a silicone including the alkyl-modified siloxane unit and the polyether-modified siloxane unit exhibited excellent liquid resin stability and exhibited excellent surface slip characteristics and ink adhesion of the cured product.

1. A curable liquid resin composition, comprising (A) a silicone product including a silicone (A1) including in its structure an alkyl-modified siloxane unit and a polyether-modified siloxane unit.

2. The curable liquid resin composition according to claim 1, wherein the alkyl-modified siloxane unit and the polyether-modified siloxane unit respectively account for 0.5-45 mol % and 0.5-25 mol % of the total siloxane units included in the silicone (A1).

3. The curable liquid resin composition according to claim 1, further comprising (B) a urethane (meth)acrylate obtained by reacting a polyol compound, a polyisocyanate compound, and a hydroxyl group-containing (meth)acrylate compound.

4. A curable liquid resin composition according to claim 1, further comprising (C) a polymerizable diluent.

5. A curable liquid resin composition according to claim 1, wherein (A) is present in an amount of 0, 1-20 mass %, relative to the total composition.

6. A curable liquid resin composition according to claim 3, wherein (B) is present in an amount of 30-90 mass %, relative to the total composition.

7. A curable liquid resin composition according to claim 4, wherein (C) is present in an amount of 0-80 mass %, relative to the total composition.

8. The curable liquid resin composition according to claim 1, which is used to coat an optical fiber.

9. Coated and optionally inked optical fiber comprising a glass optical fiber having a primary coating, a secondary coating, and optionally an ink composition applied thereon, said coated optical fiber being adapted for use in a ribbon by encapsulating a plurality of said coated fibers in a matrix material, wherein at least one of said coating, ink composition or matrix material is a cured radiation-curable composition according to claim 1.
